(19) United States
(12) Patent Application Publication
(10) Pub. No.: US 2007/0097824 A1
(43) Pub. Date: May 3, 2007

(54) Off-track relief processing method for optical disk apparatus, and optical disk apparatus

(75) Inventor: Hiroshi Tani, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/386,395

(22) Filed: Mar. 22, 2006

(30) Foreign Application Priority Data
Oct. 31, 2005 (JP) 2005-315702

(51) Int. Cl. G11B 7/00

(52) U.S. Cl. 369/53.29

(57) ABSTRACT

An optical disk apparatus read information recorded on the tracks of an optical disk by irradiating light onto the optical disk and control relax of an off-track detection condition by the points of off-track occurrence when the off-track is detected. In the event of off-track, a controller executes processing for detecting a point of occurrence of the off-track, and defect decision processing for deciding that the off-track is caused by a defect (dust, scratch, etc.) when the off-track is detected continuously at an identical point. In the case of read operation, the detection condition in off-track detection processing is relaxed in case the off-track continues at the identical point. Thus, it becomes possible to distinguish an off-track outbreak immediately after seek from the off-track caused by the defect, and even when the off-track outbreaks continue, the movement to a neighboring track is prevented.

### CROSS-REFERENCE TO RELATED APPLICATIONS

This application is based upon and claims the benefit of priority from the prior Japanese Patent Application No. 2005-315702, filed on Oct. 31, 2005, the entire contents of which are incorporated herein by reference.

### BACKGROUND OF THE INVENTION

1. Field of the Invention

The present invention relates to an off-track relief processing method for an optical disk apparatus for relieving occurrence of an off-track error caused by a track error signal detected by the light reflected from the medium and influenced by a medium defective of an optical disk medium, and an optical disk apparatus, and more particularly, an off-track relief processing method for an optical disk unit for detecting existence or non-existence of a defect by a track error signal, and an optical disk apparatus.

2. Description of the Related Art

With the development of optical storage technology, optical disk apparatus using optical storage disks are widely in use, which includes compact disc (CD), DVD (Digital Versatile Disk) and magneto-optical disk (MO).

In such an optical disk unit, light is irradiated from an optical head to an optical disk, and recorded information is read out by receiving reflected light of the irradiate light by means of a photodetector. At this time, both a focus position deviation FES and a track position deviation TES against the irradiated light are detected from the reflected light.

As shown in FIG. 20, a track 1002 of either spiral or concentric shape is structured on an optical disk 1000. To read and write satisfactorily, it is effective to focus the irradiated light on a recording face of the disk 1000, and to position the irradiated light on a track position of the disk 1000.

For this purpose, generally there are provided a focus control mechanism for controlling to focus an objective lens of an optical head, in response to the detected focus position deviation FES, and also a track control mechanism for controlling to position the object lens to the track position, in response to the detected track position deviation TES.

In the above mechanisms, positional deviation of the light beam in the track traverse direction across the track 1002 is detected by the track error signal TES. When the above track error signal TES exceeds a predetermined off-track slice, it is decided as off-track (track off), so as to perform a relief measure against the off-track.

FIG. 21 shows a data read processing flowchart including the conventional off-track relief measure. Referring to FIG. 20 also, the processing shown in FIG. 21 is described below. First, head seek operation to seek the head at the vicinity of an object sector (track) to be read is performed (S1), and the rotation to the object sector 1100 is waited for, while an on-track state is maintained (S2), and thereafter reading of the object sector 1100 is started (S3). During the above operation, it is detected whether the level of the track error signal TES exceeds a predetermined threshold (i.e. whether off-track has occurred). If the off-track did not occur, the operation is completed normally (S4).

On the other hand, if the occurrence of off-track is detected, it is decided whether the number of an off-track occurrence in the reading operation reaches a specified value, or greater. If the number of the off-track occurrence reaches the specified value or greater, the operation is terminated abnormally (S5). To the contrary, if the number of the off-track occurrence is less than the specified value, a defect (dust, scratch, etc.) is highly probable. Therefore, a defect relief mode is executed. In the defect relief mode, an off-track detection condition is relaxed so as to neglect the occurrence of off-track due to the track error signal TES to some extent (for example, the off-track detection threshold is set higher).

First, it is decided whether the number of the off-track occurrence reaches an effective threshold, or greater, in the defect relief mode. The above effective threshold is set smaller than the above-mentioned threshold for triggering the abnormal termination, so as to detect a prior stage to the abnormal termination. If the number of the off-track occurrence is less than the effective threshold, the process is returned to step S1 for performing retry seek operation, without execution of the defect relief mode (S6).

Meanwhile, if the number of the off-track occurrence reaches the effective threshold or more, the defect relief mode is executed. Namely, the off-track detection condition is relaxed, and the process is returned to step S1 for performing retry seek operation (S7).

As such, conventionally, on the occurrence of off-track, defective portion relief processing for relaxing the off-track detection condition to a specified level is performed in the case that the off-track occurs continuously, irrespective of whether there is a defect in particular, and then the processing proceeds to retry control. For example, in Japanese Patent Publication No. 3,635,815, there has been proposed a method of using whole signals of the reflected light for the detection to shift to the defect relief mode.

However, in recent years, as optical disk apparatus become small in size with a reduced cost, the apparatus having a single actuator commonly used as track actuator and actuator for seek movement, as actuator for moving the optical head, is currently used.

In such an optical disk apparatus, when fast seek including accurate positioning and high-speed operation is performed, there is a case that a lens of an optical head is vibrated immediately just after the positioning to a desired track following the seek operation, and the vibration remains. As a result, there has been a risk such that a frequent outbreak of track off occurs immediately after the seek operation.

In the conventional method, when off-track occurs continuously in a state of being easy to receive an external vibration immediately after the seek operation, a defect portion relief processing is performed to relax an off-track detection condition to a specified level. This causes an increase of an off-track margin, although no defect exists actually. As a result, when an optical beam improperly moves to a neighboring track, a situation that the movement cannot be detected may occur.

In particular, since the optical disk, a replaceable media, is relatively apt to have dust and scratch, a measure there for is required.

### SUMMARY OF THE INVENTION

Accordingly, it is an object of the present invention to provide an off-track relief processing method for an optical disk apparatus, and an optical disk apparatus, for executing off-track relief processing by judging whether the occurrence of continuous off-track is caused by a tentative outbreak or a defect even if the continuous off-track occurs.

It is another object of the present invention to provide an off-track relief processing method for an optical disk apparatus, and an optical disk apparatus, for avoiding movement to a neighboring track even if off-track outbreaks continue, and performing off-track relief processing against a defect.

It is still another object of the present invention to provide an off-track relief processing method for an optical disk apparatus, and an optical disk apparatus, for executing appropriate off-track relief processing even when high-speed seek operation is performed, thereby improving safety and reliability of data.

In order to achieve the aforementioned objects, according to the present invention, an optical disk apparatus at least reading information recorded on the track of an optical disk includes: an optical head for irradiating light onto the optical disk, receiving the light from the optical disk, and moving in the transversal direction of the track of the optical disk; a spindle motor for rotating the optical disk; a servo controller for controlling position of the optical head according to a track error signal generated from the light from the optical disk by means of the optical head, and also detecting off-track from the track error signal with a predetermined off track condition; and a controller for relaxing an off-track detection condition in response to a notification of the off-track. And the controller, according to the off-track detection, monitors rotation position of the optical disk in which the off-track has occurred, detects that the off-track has occurred a plurality of times in an identical position through the monitoring of the rotation position, and relaxes the off-track detection condition.

Also, according to the present invention, an off-track relief processing method for the optical disk apparatus, includes the steps of: seeking an optical head to a track having an object sector by moving the optical head, which irradiates light onto an optical disk, receives the light from the optical disk, and at least reads information recorded on the track of the optical disk, to the transversal direction of the track; detecting off-track from a track error signal generated from the light from the optical disk by means of the optical head and a predetermined off track condition; according to the off-track detection, monitoring rotation position of the optical disk in which the off-track has occurred; detecting that the off-track has occurred a plurality of times in an identical position through the monitoring of the rotation position; and relaxing the off-track detection condition.

Further, according to the present invention, preferably, the controller monitors the rotation position of the optical disk in which the off-track has occurred, from a sector ID included in a readout signal from the optical head.

Still further, according to the present invention, preferably, the controller monitors the rotation position of the optical disk in which the off-track has occurred, from the rotation position of the spindle motor.

Further, according to the present invention, preferably, the controller relaxes the off-track detection condition, on detecting the occurrence of the off-track for a plurality of times in an identical position.

Further, according to the present invention, preferably, the controller relaxes the off-track detection condition, on detecting that a ratio of the number of off-track having occurred in an identical position to the whole number of the off-track occurrence is a specified value or more.

Further, according to the present invention, preferably, the controller performs retry seek operation of the optical head, according to the off-track detection.

Further, according to the present invention, preferably, the controller performs retry seek operation of the optical head after changing the target position of the track having the object sector, according to the off-track detection.

Further, according to the present invention, preferably, the controller performs seek operation of the optical head to a different track from the target track according to the off-track detection, and after waiting for a specified time, performs retry seek operation to the target track having the object sector.

Further, according to the present invention, preferably, the controller performs seek operation of the optical head to a different track according to the off-track detection, performs retry seek operation to the track having the object sector, and then invalidates the off-track detection until the optical head reaches immediately before the object sector.

Further, according to the present invention, preferably, the controller monitors the rotation position of the optical disk in which the off-track has occurred, according to the off-track detection, and in the case that the number of the off-track occurrence reaches a specified value or more, and on detecting that the off-track has occurred a plurality of times in an identical position through monitoring the rotation position, the controller relaxes the off-track detection condition.

Further scopes and features of the present invention will become more apparent by the following description of the embodiments with the accompanied drawings.

### BRIEF DESCRIPTION OF THE DRAWINGS

FIG. 1 shows a block diagram an optical disk apparatus according to one embodiment of the present invention.

FIG. 2 shows a block diagram of a defect relief mechanism shown in FIG. 1.

FIG. 3 shows a configuration diagram of ID-rotation angle conversion processing shown in FIG. 2.

FIG. 4 shows a configuration diagram of off-track detection processing shown in FIG. 2.

FIG. 5 shows a processing flowchart of a first embodiment of the defect decision processing shown in FIG. 2.

FIG. 6 shows a processing flowchart of a second embodiment of the defect decision processing shown in FIG. 2.

FIG. 7 shows a flowchart of an off-track relief processing according to a first embodiment of the present invention.

FIG. 8 shows an explanation diagram of the operation on a medium, shown in FIG. 7.

FIG. 9 shows an explanation diagram of the defect detection operation shown in FIG. 7.

FIG. 10 shows an operation diagram, in which no defect is decided, shown in FIG. 7.

FIG. 11 shows a timing chart at the time of detecting off-track in an ordinary mode and a defect relief mode shown in FIG. 7.

FIG. 12 shows a block diagram of another defect relief mechanism shown in FIG. 1.

FIG. 13 shows a configuration diagram of off-track occurrence time-to-rotation angle conversion processing shown in FIG. 12.

FIG. 14 shows a processing flowchart of a first embodiment of the defect decision processing shown in FIG. 12.

FIG. 15 shows a processing flowchart of a second embodiment of the defect decision processing shown in FIG. 12.

FIG. 16 shows an off-track relief processing flowchart according to a second embodiment of the present invention.

FIG. 17 shows an explanation diagram of the operation on a medium, shown in FIG. 16.

FIG. 18 shows an off-track relief processing flowchart according to a third embodiment of the present invention.

FIG. 19 shows an explanation diagram of the operation on a medium, shown in FIG. 18.

FIG. 20 shows an operation explanation diagram of a conventional off-track relief processing.

FIG. 21 shows a conventional off-track relief processing flowchart.

### DETAILED DESCRIPTION OF THE INVENTION

The preferred embodiments of the present invention are described hereinafter, in order of an optical disk apparatus, an off-track relief processing mechanism, a first embodiment of the off-track relief processing, another off-track relief processing mechanism, a second embodiment of the off-track relief processing, a third embodiment of the off-track relief processing, and other embodiments. However, it is noted that the scope of the present invention is not limited to the embodiments described below.

Optical Disk Apparatus

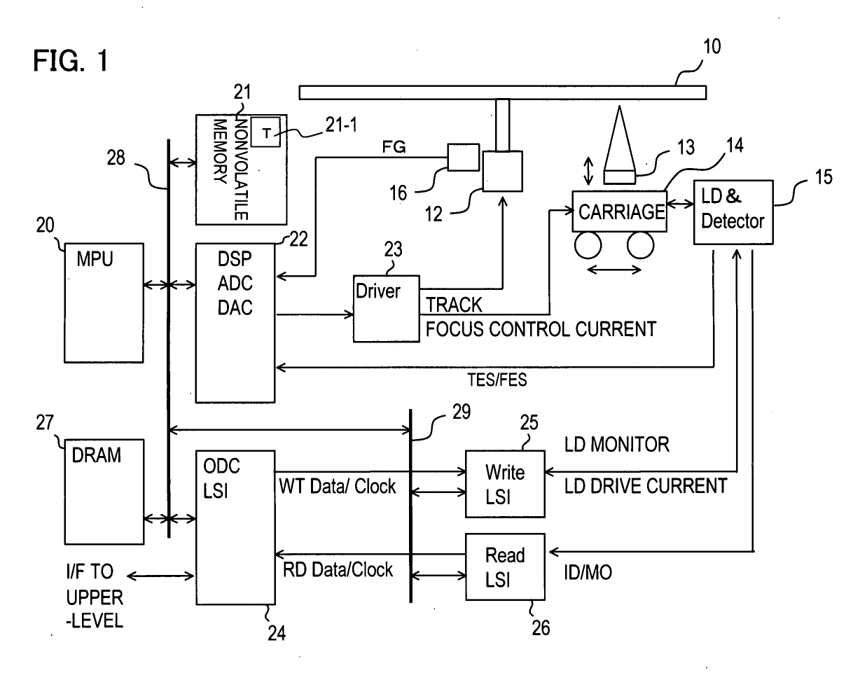

FIG. 1 shows a block diagram of an optical disk apparatus according to one embodiment of the present invention, in which a magneto-optical disk apparatus is exemplified as optical disk apparatus. As shown in FIG. 1, a magneto-optical disk cartridge 10 is inserted into the magneto-optical disk apparatus from a non-illustrated slot. The above magneto-optical disk cartridge 10 is, for example, a 3.5-inch disk.

A spindle motor 12 rotates the magneto-optical disk (hereafter referred to as MO) 10. A motor rotation angle sensor 16 detects the rotation angle of the spindle motor 12. An optical head 14, which is a moving optical system, includes a non-illustrated actuator such as a step motor, which moving in the radial direction of MO 10.

Also, optical head (which is also called carriage) 14 includes an objective lens 13, and a focus actuator (not shown) which drives the objective lens 13 in the focus direction (shown by an up and down arrow in the figure).

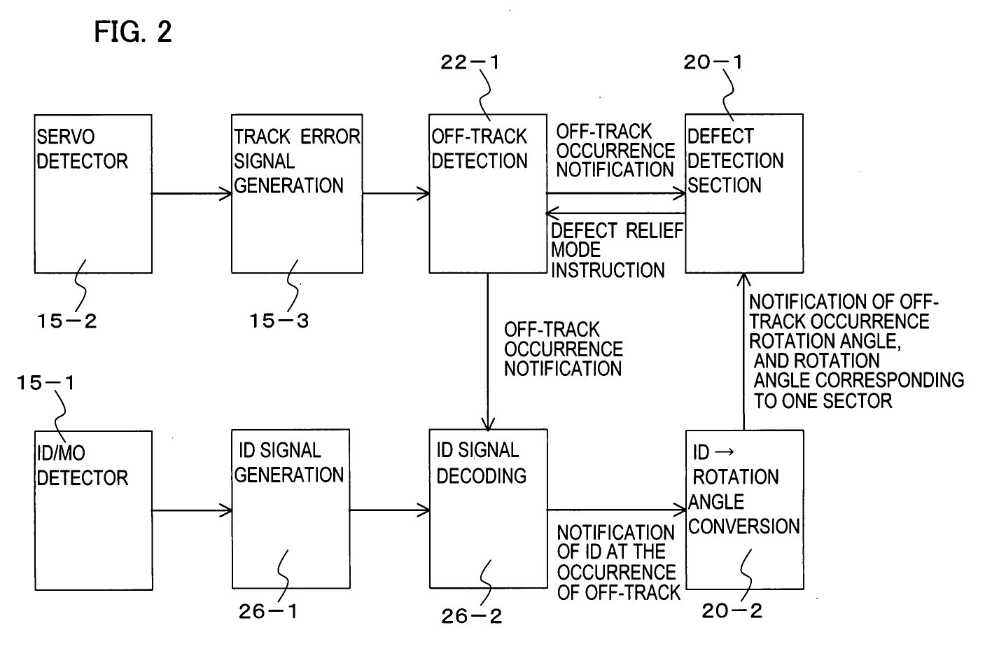

Further, in a fixed optical system (laser diode (LD) and detector) 15, there are provided a laser diode, which is a light source illustrated in FIG. 2, photo-detectors 15-1, 15-2, and an optical system which radiates light from the laser diode into carriage 14, receives the reflected light from MO 10 via objective lens 13 and introduces it to the photo-detectors 15-1 and 15-2.

A write circuit (LSI) 25 changes a laser diode (LD) drive current of the fixed optical system 15 according to a read/write/erase instruction. At the time of writing, the write circuit 25 modulates the LD drive current by a write data. Also, the write circuit 25 monitors the output of the laser diode, and performs APC (automatic power control).

A read circuit (LSI) 26 identifies an ID signal from the output of the photo-detector 15-1, and regulates an MO signal (read data) to a data format. An ODC (optical drive controller) circuit (LSI) 24 performs interface control with an upper-level device, and also performs synchronization control of write data/read data between the upper-level device and write/read circuits 25, 26, using a RAM (random access memory) 27.

An MPU (microprocessor unit) 20 performs control of the overall unit. According to the embodiment of the present invention, MPU 20 performs off-track relief processing. A nonvolatile memory 21 stores program, data, and table 21-1 necessary for the processing in MPU 20. According to the embodiment, nonvolatile memory 21 stores an off-track position detection table 21-1. Also, RAM 27 stores the number of an off-track occurrence, etc.

A DSP (digital signal processor) 22 performs servo control of the step motor, the spindle motor 12 and the focus actuator. According to a detection angle detected by the motor rotation angle sensor 16, DSP 22 controls rotation of the spindle motor 12, performs focus servo control in response to the focus error signal FES from the photo-detector 15-2, and controls the focus actuator through a driver 23.

Further, DSP 22 performs off-track detection (which will be described later in 22-1 shown in FIG. 2) from the track error signal TES received from photodetector 15-2. DSP 22 also performs track servo control in response to the track error signal TES, and controls the actuator (the step motor) of carriage 14 through the driver 23.

A main bus 28 connects MPU 20, RAM 27, ODC 24, DSP 22 and the nonvolatile memory 21. Further, a sub-bus 29 connects MPU 20, the write circuit 25 and the read circuit 26.

Next, the operation of fixed optical system 15 and moving optical system 14 is described hereafter. The light emitted from the laser diode in the fixed optical system 15 is converted into parallel light through a collimator lens, and then is split by a beam splitter, and is incident into the moving optical system 14. In the moving optical system 14, the light is incident on objective lens 13 through a rising mirror, and then is irradiated the MO 10 through the objective lens 13.

The APC photodetector disposed in the fixed optical system 15 receiving the light from the laser diode through the beam splitter, and outputs an LD monitor current to the write circuit 25.

Meanwhile, the reflected light from the MO 10 is incident on the objective lens 13, and incident on the fixed optical system 15 through the rising mirror. In the fixed optical system 15, the light is incident on the photo-detectors 15-1, 15-2 through the beam splitter and the lens unit. The photo-detectors 15-1, 15-2 are structured of known four-divided detector, and output the focus error signal FES, the track error signal TES, and the whole signals MO using the known arithmetic operation.

According to the embodiment of the present invention, as described in FIG. 2 or later, off-track relief processing provided in MPU 20 identifies a portion of an off-track occurrence (position), and on detecting the off-track for a plurality of times at an identical portion, the off-track relief processing decides that there is a defect at the portion concerned, so as to relax the off-track detection condition.

Off-track Relief Mechanism

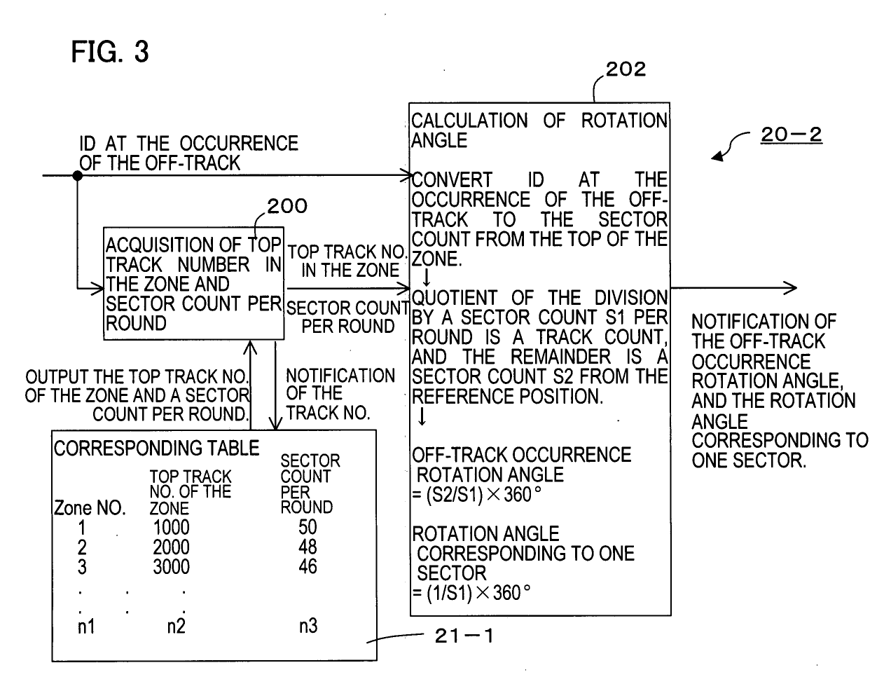

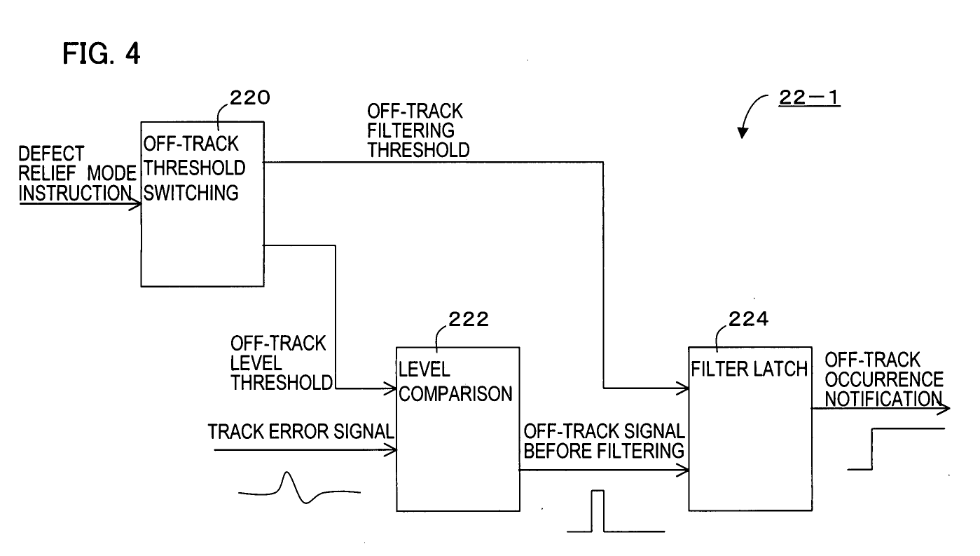

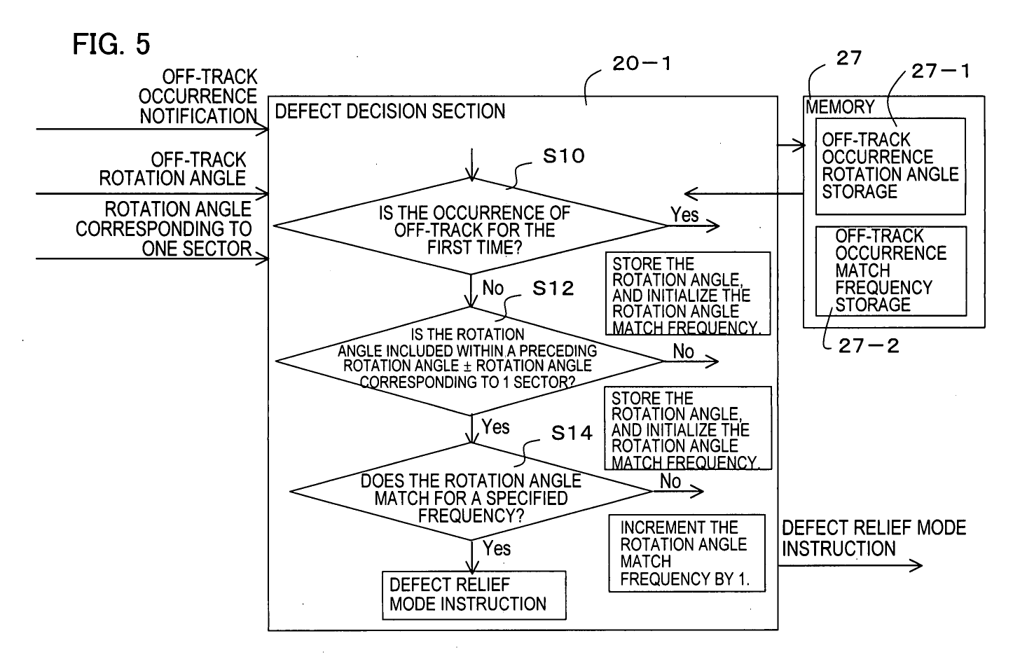

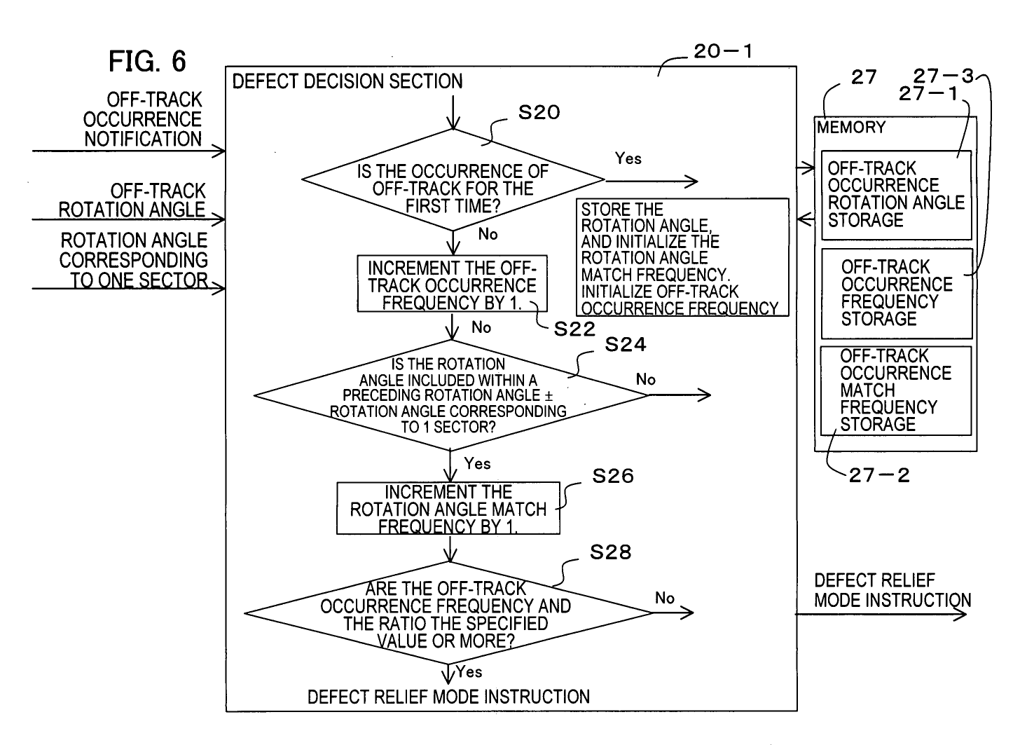

FIG. 2 shows a block diagram of an off-track relief mechanism shown in FIG. 1; FIG. 3 shows a block diagram of ID-rotation angle conversion processing shown in FIG. 2; FIG. 4 shows a block diagram of an off-track detection section shown in FIG. 2; FIG. 5 shows a block diagram of the defect decision section shown in FIG. 2, and FIG. 6 shows a block diagram of another defect decision section shown in FIG. 2.

As shown in FIG. 2, a second photodetector 15-2 functions as servo detector. A track error signal generation circuit 15-3 is provided in the fixed optical system 15, and generates a track error signal TES from the detection signal detected in the above second photodetector (hereafter referred to as servo detector) 15-2, through the known arithmetic operation. The above track error signal TES is input to DSP 22, and used for off-track detection processing 22-1 which will be described in FIG. 4.

First photodetector 15-1 functions as ID/MO detector, and outputs the whole signals. Meanwhile, an ID signal generation circuit 26-1 and an ID signal decoding circuit 26-2 are provided in the read circuit 26. The ID signal generation circuit 26-1 generates an ID signal (sector ID signal) from the output of the first photodetector 15-1. Further, the ID signal decoding circuit 26-2 decodes the generated ID signal, and outputs an ID (track number and sector number).

MPU 20 executes an ID-rotation angle conversion processing 20-2 and a defect decision processing 20-1. As described in FIG. 3, the ID-rotation angle conversion processing 20-2 converts the ID notified from the ID signal decoding circuit 26-2 to a disk off-track occurrence rotation angle and a rotation angle corresponding to one sector.

From the rotation angle notified from the ID-rotation angle conversion processing 20-2, the defect decision processing 20-1 decides whether the off-track is detected for a plurality of times at an identical point, so as to decide whether there is a defect. The above defect decision processing 20-1 will be described in FIGS. 5 and 6.

DSP 22 executes an off-track detection processing 22-1. The off-track detection processing 22-1 detects a track error signal TES under a predetermined off-track detection condition. On detecting the off-track, the off-track detection processing 22-1 notifies the defect decision processing 20-1 and the ID signal decoding circuit 26-2 of the occurrence of the off-track. Further, in response to a defect relief mode instruction from the defect decision processing 20-1, the off-track detection processing 22-1 changes the off-track detection condition. The above off-track detection processing 22-1 will be described later in FIG. 4.

Now, referring to FIG. 3, the ID-rotation angle conversion processing 20-2 is described hereafter. In FIG. 3, there is shown a format example having a plurality of zones divided in the radial direction of the disk, and having a different sector count per track in each zone. First, the table 21-1 is prepared in the nonvolatile memory 21.

In the table 21-1, each zone number, a top track number in each zone, and a sector count in one round (one track) of the zone are stored. In the ID-rotation angle conversion processing 20-2, first, table reference processing 200 refers to the table 21-1, using the ID (track number) at the occurrence of the off-track, so as to obtain the top track number in the zone having the track number concerned, and a sector count S1 included in one round having the track number concerned.

A rotation angle calculation processing 202 converts the ID at the occurrence of the off-track into the sector count from the top of the zone, from the ID (track number and sector number) at the occurrence of the off-track, the top track number of the zone concerned, and the sector count S1 provided in one round having the track number. Also, the rotation angle calculation processing 202 divides the above converted sector count by the sector count provided in one round, and obtains the sector count S2 from the reference position in one round of the disk, using the remainder of the above division. Additionally, the quotient of the above division is the track count.

The rotation angle calculation processing 202 calculates an off-track occurrence rotation angle A1 from the formula (1) shown below, and also calculates a rotation angle A2 corresponding to one sector from the formula (2) shown below.
A1=S2/S1×360° (1)
A2=1/S1×360° (2)

As such, from the ID at the occurrence of the off-track, the rotation angle A1 of the sector at the occurrence of the off-track and the rotation angle A2 per sector in the sector of interest are obtained.

Next, referring to FIG. 4, the processing in the off-track detection processing 22-1 shown in FIG. 2 is described. In the off-track detection processing 22-1, off-track is detected under two conditions. Namely, in level comparison processing 222, it is decided whether the track error signal TES (digital conversion value) exceeds the off-track level threshold. Also, in filter latch processing 224, the off-track signal prior to filtering, which is decided as off-track in the level comparison, is filtered with a predetermined off-track filtering threshold. The above filter latch processing 224 issues an off-track occurrence notification when the time width of the off-track signal prior to the filtering exceeds a predetermined off-track threshold, Meanwhile, when the above time width of the off-track signal does not exceed the predetermined off-track threshold, the filter latch processing 224 neglects the off-track signal prior to the filtering, and does not issue the off-track occurrence notification.

The above off-track detection processing 22-1 further includes off-track threshold switching processing 220, in which the off-track level threshold and the off-track filtering threshold are changed according to the defect relief mode instruction. For example, when the defect relief mode instruction is ON, both the off-track level threshold and the off-track filtering threshold are increased, so as to relax the off-track detection condition.

Next, referring to FIG. 5, the defect decision processing 20-1 shown in FIG. 2 is described. As shown in FIG. 5, on receipt of an off-track occurrence notification from the off-track detection processing 22-1, the defect decision processing 20-1 reads out the off-track rotation angle A1 and the rotation angle A2 corresponding to one sector, from the ID-rotation angle conversion processing 20-2.

On receipt of the off-track occurrence notification, the defect decision processing 20-1 decides whether the off-track concerned is a first-time occurrence. In case of the first-time occurrence, the defect decision processing 20-1 stores the readout rotation angle A1 into an off-track occurrence rotation angle storage area 27-1 of the memory 27, and also initializes (for example, zero resets) the number of a rotation angle match storage area 27-2 of memory 27 (S10).

To the contrary, if it is decided that the off-track is not a first-time occurrence, the defect decision processing 20-1 compares the rotation angle A1(1) of the first time, which is stored in the off-track occurrence rotation angle storage area 27-1, with the off-track occurrence rotation angle A1(n), which is read out this time, so as to decide whether the off-track rotation angle A1(n) being read out this time lies within the range of the rotation angle A(1) of the first time ±A2 (rotation angle corresponding to one sector). Here, the reason for using the range of ‘± rotation angle corresponding to one sector’ is to allow a detection margin. Then, if the off-track rotation angle A1(n) being read out this time does not lie within the range of the rotation angle A(1) of the first time ±A2 (rotation angle corresponding to one sector), it is decided that the off-track did not occur at an identical point. Accordingly, the rotation angle A1(n) being read out this time is stored into the off-track occurrence rotation angle storage area 27-1 of the memory 27, and the number of rotation angle match storage area 27-2 of the memory 27 is initialized (for example, zero reset) (S12).

To the contrary, if the off-track rotation angle A1(n) being read out this time lies within the range of the stored rotation angle A(1)±A2 (rotation angle corresponding to one sector), it is decided that the off-track occurred at an identical point. Next, it is decided whether the number of matching stored in the number of rotation angle match storage area 27-2 of the memory 27 is a specified value (for example, on the order of 10 times) or more. If the number of matching is less than the specified value, then the number of matching stored in the number of rotation angle match storage area 27-2 of the memory 27 is incremented by one. On the other hand, if the number of matching is no less than the specified value, the defect relief mode is instructed (S14).

As such, on the occurrence of off-track, the point of occurrence of off-track is examined. When the occurrence of continuous off-track is detected at an identical point, it is decided to be a defect (dust, scratch, deterioration, etc.). Further, in the case of read operation, the defect relief mode is instructed to the off-track detection processing 22-1, so as to relax the off-track detection condition. To the contrary, in the case that off-track does not occur continuously at an identical point, it is decided that the off-track is not caused by a defect, and the off-track detection condition is not relaxed.

Next, referring to FIG. 6, another embodiment of the defect decision processing 20-1 shown in FIG. 2 is described below. In FIG. 6, whether a defect or not is decided based on not only the number of matching, but also the ratio of the number of matching. As shown in FIG. 6, on receipt of an off-track occurrence notification from the off-track detection processing 22-1, the defect decision processing 20-1 reads out the off-track rotation angle A1 and the rotation angle A2 corresponding to one sector, from the ID-rotation angle conversion processing 20-2.

On receipt of the off-track occurrence notification, the defect decision processing 20-1 decides whether the off-track concerned has occurred for the first time. If the off-track has occurred for the first time, the defect decision processing 20-1 stores the readout rotation angle A1 into the off-track occurrence rotation angle storage area 27-1 of the memory 27, and also initializes (for example, zero resets) both the number of rotation angle match storage area 27-2 and the number of the off-track occurrence storage area 27-3 provided in the memory 27 (S20).

To the contrary, if it is decided that the off-track is not a first-time occurrence, the defect decision processing 20-1 increments the number of the off-track occurrence in the memory 27 by one (S22). Next, the defect decision processing 20-1 compares the rotation angle A1(1) of the first time, which is stored in the off-track occurrence rotation angle storage area 27-1, with the off-track occurrence rotation angle A1(n), which is read out this time, so as to decide whether the off-track rotation angle A1(n) being read out this time lies within the range of the rotation angle A(1) of the first time ±A2 (rotation angle corresponding to one sector). Here, the reason for using the range of ‘± rotation angle corresponding to one sector’ is to allow a detection margin. Then, if the off-track rotation angle A1(n) being read out this time does not lie within the range of the rotation angle A(1) of the first time ±A2 (rotation angle corresponding to one sector), it is decided that the off-track did not occur at an identical point, and accordingly, the off-track concerned is neglected (S24).

To the contrary, if the off-track rotation angle A1(n) being read out this time lies within the range of the stored rotation angle A(1)±A2 (rotation angle corresponding to one sector), it is decided that the off-track occurred at an identical point. Then, the number of matching stored in the number of rotation angle match storage area 27-2 of the memory 27 is incremented by one (S26).

Subsequently, it is decided whether the number of the off-track occurrence stored in the memory 27 is a specified value (for example, 10 times) or more. If the number of the off-track occurrence is less than the specified value, the defect relief mode processing is not performed. To the contrary, if the number of off-track occurrence is the specified value or more, by dividing the number of matching stored in the number of rotation angle match storage area 27-2 by the number of the off-track occurrence stored in the memory 27, a ratio of the number of matching to the number of the off-track occurrence is calculated. Then, it is decided whether the above ratio of the number of matching is a specified value (for example, 90%), or more. If the above ratio is less than the specified value, the defect relief mode processing is not performed. On the other hand, if the above ratio is no less than the specified value, the defect relief mode is instructed (S28).

As such, on the occurrence of off-track, the point of occurrence of the off-track is examined. The occurrence of frequent off-track at an identical point is detected by calculating the ratio of the number of matching of the defective rotation angle to the number of the off-track occurrence, so as to decide to be a defect (dust, scratch, etc.). Further, in the case of read operation, the defect relief mode is instructed to off-track detection processing 22-1, so as to relax the off-track detection condition. To the contrary, in the case that off-track does not occur frequently at an identical point, it is decided that the off-track is not caused by a defect, and the off-track detection condition is not relaxed.

First Embodiment of Off-track Relief Processing

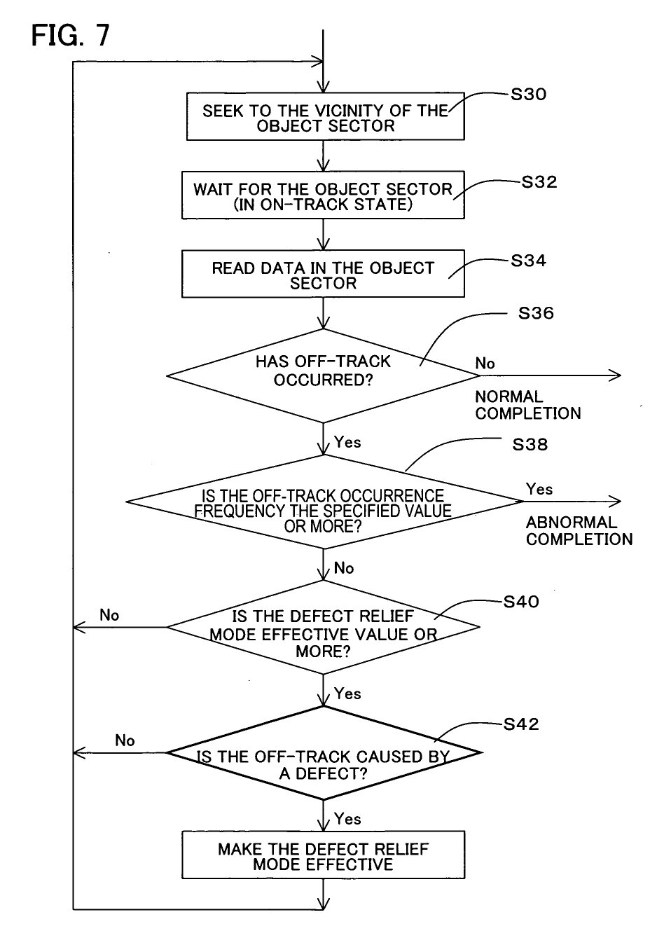

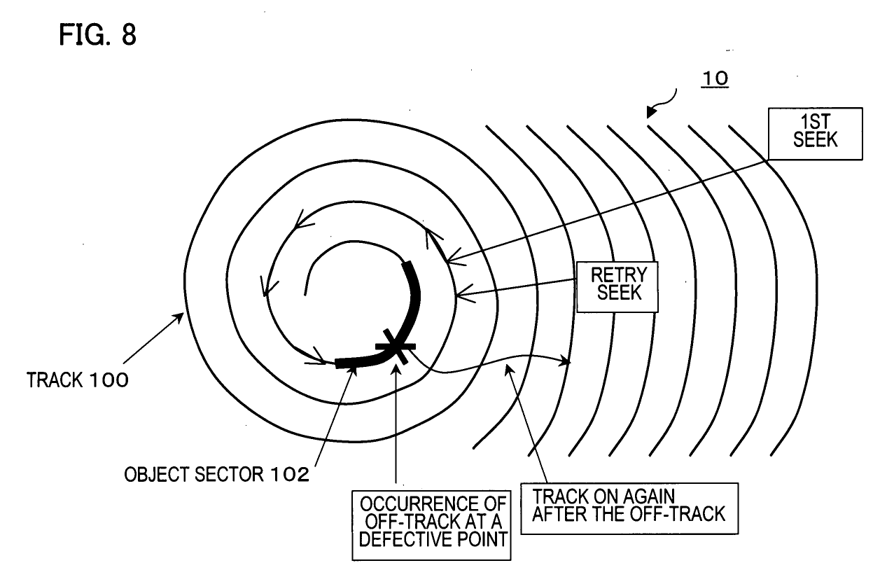

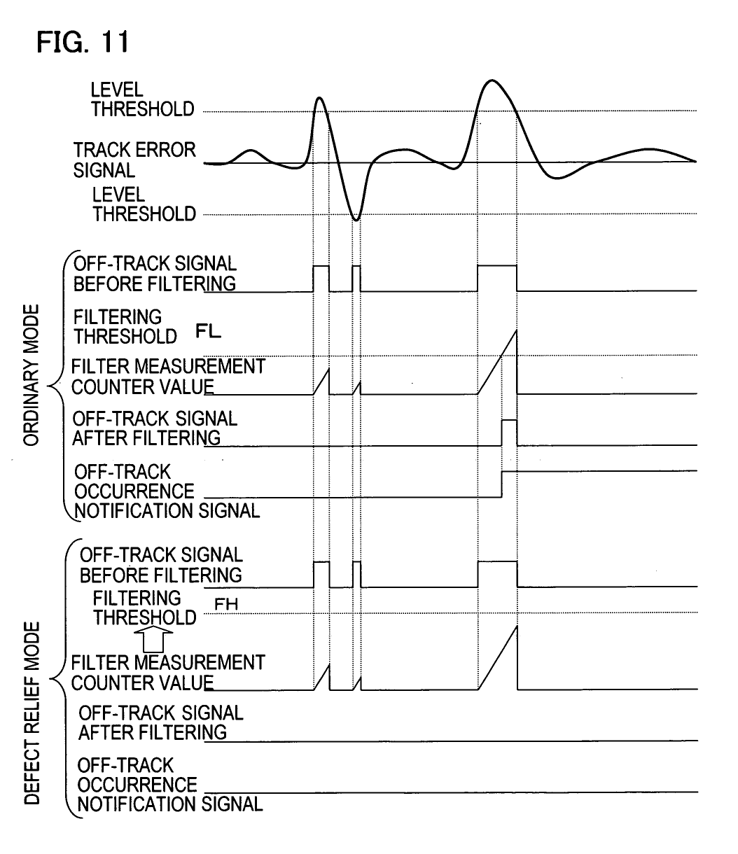

Next, off-track relief processing executed by MPU 20 is described hereafter. FIG. 7 shows an off-track relief processing flowchart according to a first embodiment of the present invention. FIGS. 8 through 10 show operation explanation diagram thereof, and FIG. 11 shows a timing chart of the relief processing thereof.

Hereafter, referring to FIGS. 8 through 11, the processing shown in FIG. 7 is described.

(S30) MPU 20 issues a command to DSP 22 so as to perform seek operation of the carriage 14 to the vicinity of an object sector (track) to be read. DSP 22 detects a current position from a sector ID, and performs seek control of the carriage 14 by use of a position error between the target position and the current position through known seek operation.

(S32) On detection of the carriage 14 reaching the target position (track 100 having object sector 102 shown in FIG. 8) from the sector ID, MPU 20 waits for the rotation while maintaining an on-track state of the light beam of the carriage 14.

(S34) MPU 20 starts read operation of object sector 102 through the read circuit 26. The read data is then transferred to RAM 27 from the read circuit 26.

(S36) In the mean time, DSP 22 detects whether the level of the track error signal TES exceeds a predetermined threshold (i.e. whether off-track has occurred) through the off-track detection processing 22-1. If no occurrence of the off-track is notified from DSP 22, MPU 20 completes the processing normally. In this case, the ODC circuit 24 transfers data of RAM 27 to the host.

(S38) On the other hand, on detection of the off-track during reading the read object sector 102, DSP 22 notifies MPU 20 of the above detection. MPU 20 counts the number of an off-track occurrence, and decides whether the number of the off-track occurrence reaches a specified value or more during the read operation concerned. If the number of the off-track occurrence is equal or more than the specified value (for example, 16 times), the processing is terminated abnormally.

(S40) To the contrary, if the number of the off-track occurrence is less than the specified value, it is highly probable that a defect (dust, scratch, etc.) has occurred. Therefore, first, MPU 20 decides whether the number of the off-track occurrence is no less than an effective threshold of the defect relief mode (for example, 10 times). The above effective threshold is set smaller than the aforementioned threshold for triggering the abnormal termination. Namely, the effective threshold is provided for detecting a prior stage to the abnormal termination. If the number of the off-track occurrence is less than the above effective threshold, the process is returned to step S30 for performing retry seek operation, without execution of the defect relief mode. As shown in FIGS. 8 through 10, after moving the carriage 14 to a different track once, MPU 20 seeks the track having the object sector again.

(S42) Meanwhile, if the number of the off-track occurrence is no less than the effective threshold, as shown in FIGS. 5 and 6, MPU 20 decides whether the off-track occurs continuously or frequently at the point of occurrence (rotation position) of the off-track through the defect decision processing 20-1, so as to decide whether the off-track is caused by a defect. When the defect decision processing 20-1 decides that the off-track is not caused by a defect, MPU 20 does not execute the defect relief mode. Instead, the process is returned to step S30 for performing retry seek operation. As shown in FIGS. 8 through 10, after moving the carriage to a different track once, MPU 20 seeks the track having the object sector again. To the contrary, when the defect decision processing 20-1 decides that the off-track is caused by a defect, MPU 20 instructs the off-track detection processing 22-1 in DSP 22 to perform the defect relief mode, and relaxes the off-track detection condition. Thereafter, the process is returned to step S30 for performing retry seek operation.

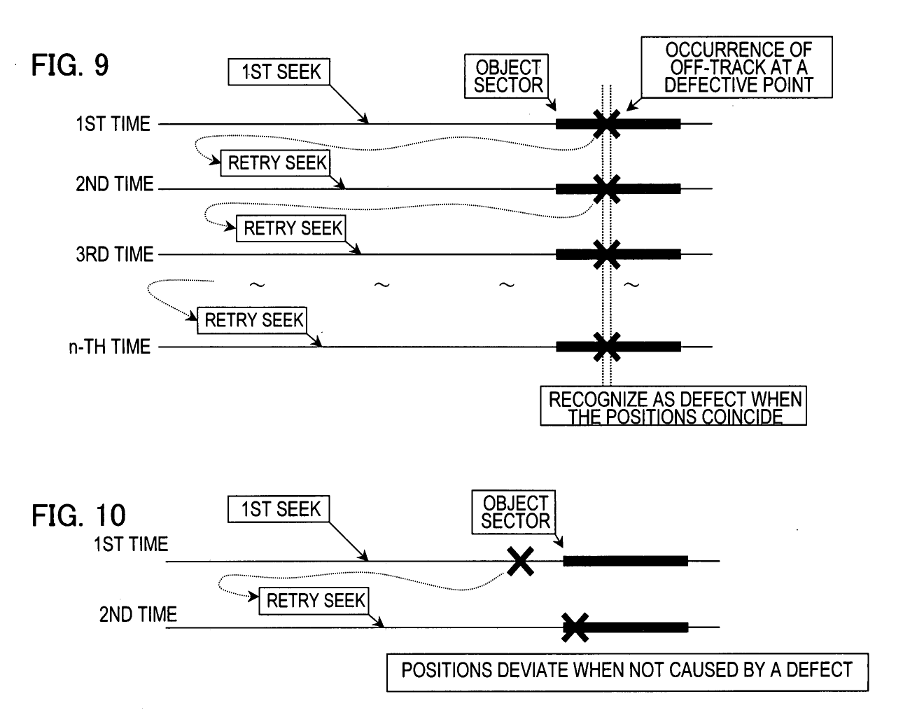

FIG. 9 shows an explanation diagram in case of being decided as a defect, and FIG. 10 shows an explanation diagram in case of being not decided as a defect. As shown in FIG. 9, at the first seek, when the off-track is detected while tracing the track to read the object sector, the point of occurrence of the off-track is detected and stored. Further, at the second, third, . . . n-th retry seek operation, when the off-track is detected while tracing the track to read the object sector, the point of occurrence of the off-track is detected. In the case that the above off-track continuously occurs at an identical point, it is decided that the off-track is caused by a defect.

On the other hand, as shown in FIG. 10, at the first seek, when the off-track is detected while tracing the track to read the object sector, the point of the occurrence of the off-track is detected and stored. Further, at the second retry seek operation or after, when the off-track is detected while tracing the track to read the object sector, the point of occurrence of the off-track is detected. As compared with the position of the first off-track, since the off-track positions are different, it is decided that the off-track is not caused by a defect.

As the causes of the situation shown in FIG. 10, a case of residual vibration remaining in the carriage 14, or a case of receiving vibration from outside are considered. In such cases, the off-track breaks out immediately after the seek operation. If the off-track detection condition is relaxed in such a case, it is probable that a light beam moves to a neighboring track, and as a result, there is a risk that the operation of tracing the track to an object sector cannot be performed satisfactorily.

Meanwhile, as shown in FIG. 9, when the off-track occurs at an identical point either frequently or continuously, it is considered that the off-track may not be an outbreak but persistent event caused by a defect. Accordingly, the read operation can be continued by relaxing the off-track detection condition and performing retry.

FIG. 11 shows a timing chart of off-track detection in an ordinary mode and a defect relief mode. For a track error signal TES as shown in FIG. 11, comparison with an off-track level threshold is performed in the level comparison processing 222 shown in FIG. 4. When the track error signal TES exceeds the level threshold, an off-track signal prior to filtering is set high. The period of the off-track signal being in the high state is counted in the filter latch processing 224. When the count value exceeds a filtering threshold, the off-track signal is set high.

In the ordinary mode, the filtering threshold is set to a low filtering threshold FL, and when the defect relief mode is instructed, the off-track threshold switching processing 220 shown in FIG. 4 switches the threshold to a high off-track filtering threshold FH. As a result, as shown in FIG. 11, although an off-track occurrence notification signal becomes high in the ordinary mode, the off-track occurrence notification signal does not become high in the defect relief mode.

If the period of the track error signal TES exceeding the level threshold continues for a long time, it is highly probable that either movement to the neighboring track or a read error occurs. According to the present embodiment, by changing the filtering threshold, movement to the neighboring track or occurrence of the read error can be avoided and read operation can be continued, even when a defect exists.

It is desirable that, the above low filtering threshold FL is set to a value so as to maintain a stable track tracing capability under the circumstance of vibration within a certain limit, and the high filtering threshold is set to a value so as to produce neither movement to the neighboring track nor an read error.

Another Off-track Relief Mechanism

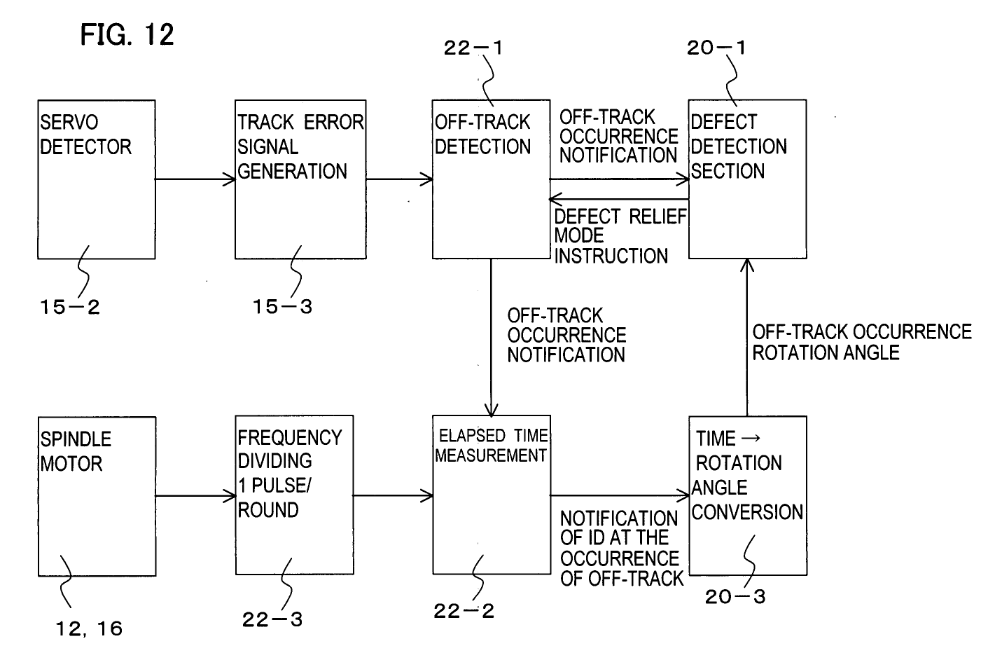

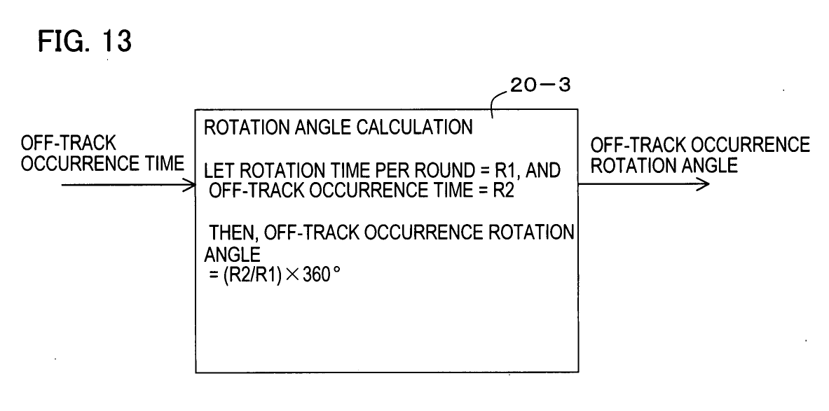

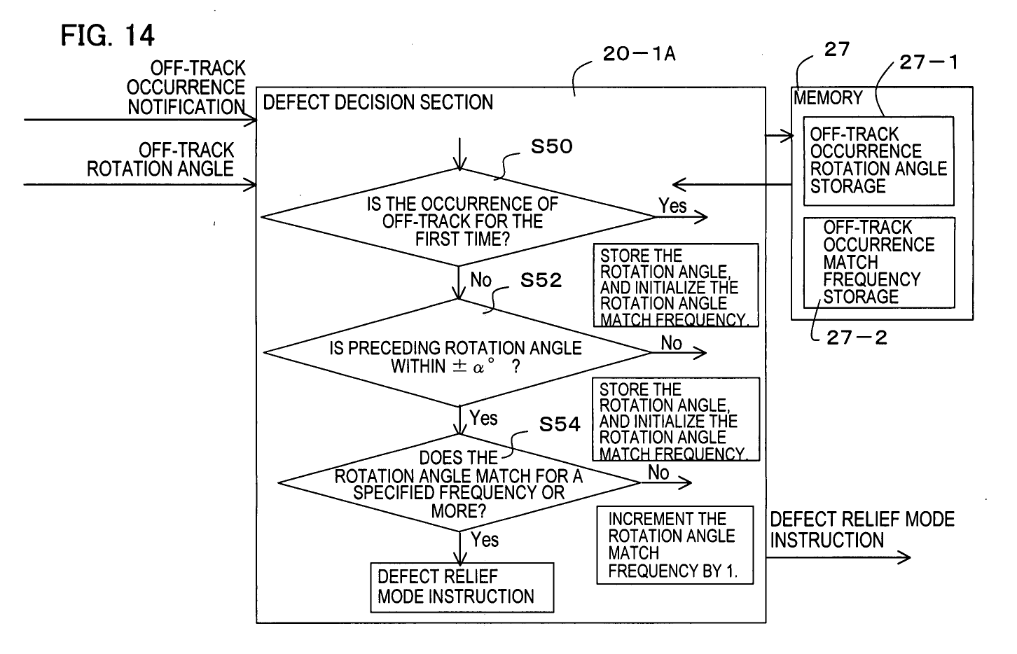

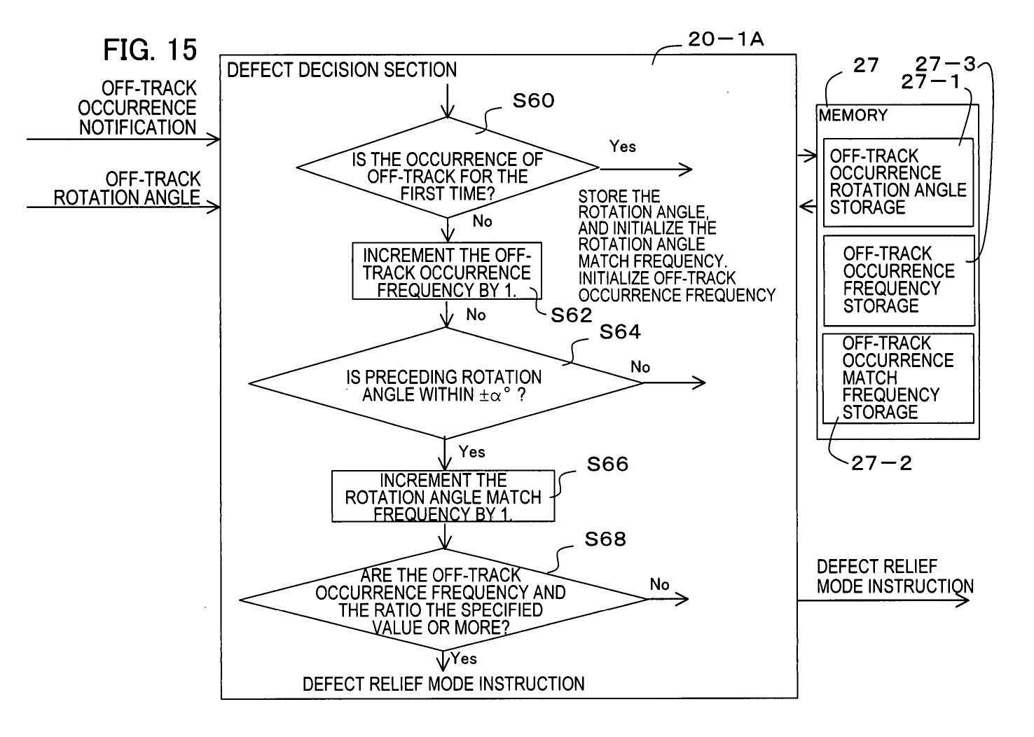

FIG. 12 shows a block diagram of another defect relief mechanism shown in FIG. 1. FIG. 13 shows a block diagram of processing for off-track occurrence time-to-rotation angle conversion shown in FIG. 12. FIG. 14 shows a block diagram of the defect decision section shown in FIG. 12. Also, FIG. 15 shows another block diagram of the defect decision section shown in FIG. 12.

In FIG. 12, like numerals refer to like parts shown in FIGS. 2 through 4. As shown in FIG. 12, track error signal generation circuit 15-3 is provided in the fixed optical system 15, and generates a track error signal TES from the detection signal detected in the second photodetector (which is also referred to as servo detector) 15-2, through the known arithmetic operation. The above track error signal TES is input to DSP 22, and used for the off-track detection processing 22-1 described in FIG. 4.

A rotation detector 16 for detecting the rotation of spindle motor 12 shown in FIG. 1 detects the rotation, and generates an FG pulse corresponding to the rotation speed. For example, the resolution of the rotation position is 1,000/one rotation. A frequency division circuit 22-3 in DSP 22 divides the frequency of the FG pulse, and outputs one pulse per rotation. On receiving one rotation pulse from the frequency division circuit 22-3, an elapsed time measurement circuit 22-2 in DSP 22 starts a timer. Also, on receipt of an off-track occurrence notification from the off-track detection circuit 22-1, the elapsed time measurement circuit 22-2 informs off-track occurrence time-to-rotation angle conversion processing 20-3 about the timer value at that time as an off-track occurrence time.

MPU 20 executes the off-track occurrence time-to-rotation angle conversion processing 20-3 and the defect decision processing 20-1. As shown in FIG. 13, R1 denote a period of rotation per round of disk 10. Then, from an off-track occurrence time R2, the off-track occurrence time-to-rotation angle conversion processing 20-3 calculates an off-track occurrence rotation angle A1 from the formula (3) shown below.
A1=R2/R1×360° (3)

At the time the occurrence of off-track is notified, using the rotation angle received from the off-track occurrence time-to-rotation angle conversion processing 20-3, the defect decision processing 20-1A decides whether the off-track has been detected for a plurality of times at an identical point, so as to decide whether a defect exits. The above defect decision processing 20-1A will be described later, referring to FIGS. 5 and 6.

As described in FIG. 4, the off-track detection processing 22-1 detects the track error signal TES under the off-track detection condition. On detecting the off-track, the off-track detection processing 22-1 informs both the defect decision processing 20-1A and the elapsed time measurement processing 22-2 about the occurrence of the off-track. Further, in response to an instruction of the defect relief mode from the defect decision processing 20-1, the off-track detection processing 22-1 changes the off-track detection condition.

Next, referring to FIG. 14, the defect decision processing 20-1A shown in FIG. 12 is described. As shown in FIG. 14, on receipt of the off-track occurrence notification, the defect decision processing 20-1A reads out the off-track rotation angle A1 from the off-track occurrence time-to-rotation angle conversion processing 20-3.

On receipt of the off-track occurrence notification, the defect decision processing 20-1A decides whether the off-track is a first-time occurrence. In case of the first-time occurrence, the defect decision processing 20-1A stores the readout rotation angle A1 into the off-track occurrence rotation angle storage area 27-1 of the memory 27, and also initializes (for example, zero resets) the number of rotation angle match storage area 27-2 of the memory 27 (S50).

To the contrary, when it is decided the off-track is not a first-time occurrence, the defect decision processing 20-1A compares the rotation angle A1(1) of the first time, which is stored in the off-track occurrence rotation angle storage area 27-1, with the off-track occurrence rotation angle A1(n), which is read out this time, so as to decide whether the off-track rotation angle A1(n) being read out this time lies within the range of the rotation angle A(1) of the first time ±α°. Here, the reason for using the range of ±α° is to allow a detection margin. Then, if the off-track rotation angle A1(n) being read out this time does not lie within the range of the rotation angle A(1) of the first time ±α°, it is decided that the off-track did not occur at an identical point. Accordingly, the rotation angle A1(n) being read out this time is stored into the off-track occurrence rotation angle storage area 27-1 of the memory 27, and the number of rotation angle match storage area 27-2 of the memory 27 is initialized (for example, zero reset) (S52).

To the contrary, if the off-track rotation angle A1(n) being read out this time lies within the range of the stored rotation angle A(1)±α°, it is decided that the off-track occurred at an identical point. Next, it is decided whether the number of matching stored in the number of rotation angle match storage area 27-2 of the memory 27 is a specified value (for example, on the order of 10 times) or more. If the number of matching is less than the specified value, then the number of matching stored in the number of rotation angle match storage area 27-2 of the memory 27 is incremented by one. On the other hand, if the number of matching is no less than the specified value, the defect relief mode is instructed (S54).

As such, on the occurrence of off-track, a point (position) of occurrence of the off-track is examined. When the occurrence of continuous off-track is detected at an identical point, it is decided to be a defect (dust, scratch, etc.) Further, in the case of read operation, the defect relief mode is instructed to the off-track detection processing 22-1, so as to relax the off-track detection condition. To the contrary, in the case that off-track does not occur continuously at an identical point, it is decided that the off-track is not caused by a defect, and the off-track detection condition is not relaxed.

Next, referring to FIG. 15, another embodiment of defect decision processing 20-1A shown in FIG. 12 is described below. In FIG. 15, whether a defect or not is decided based on not only the number of matching, but also the ratio of the number of matching. As shown in FIG. 15, on receipt of an off-track occurrence notification from the off-track detection processing 22-1, the defect decision processing 20-1A reads out the off-track rotation angle A1 from the off-track occurrence time-to-rotation angle conversion processing 20-3.

On receipt of the off-track occurrence notification, the defect decision processing 20-1A decides whether the off-track concerned is a first-time occurrence. In case of the first-time occurrence, the defect decision processing 20-1A stores the readout rotation angle A1 into the off-track occurrence rotation angle storage area 27-1 of the memory 27, and also initializes (for example, zero resets) both the number of rotation angle match storage area 27-2 and the number of off-track occurrence storage area 27-3 provided in the memory 27 (S60).

To the contrary, if it is decided the off-track is not a first-time occurrence, the defect decision processing 20-1A increments the number of the off-track occurrence in the memory 27 by one (S62). Next, the defect decision processing 20-1A compares the rotation angle A1(1) of the first time, which is stored in the off-track occurrence rotation angle storage area 27-1, with the off-track occurrence rotation angle A1(n), which is read out this time, so as to decide whether the off-track rotation angle A1(n) being read out this time lies within the range of the rotation angle A(1) of the first time ±α°. Here, the reason for using the range of ±α° is to allow a detection margin. Then, if the off-track rotation angle A1(n) being read out this time does not lie within the range of the rotation angle A(1) of the first time ±α°, it is decided that the off-track did not occur at an identical point, and accordingly, the off-track concerned is neglected (S64).

To the contrary, if the off-track rotation angle A1(n) being read out this time lies within the range of the stored rotation angle A(1)±α°, it is decided that the off-track occurred at an identical point. Then, the number of matching stored in the rotation angle match frequency storage area 27-2 of the memory 27 is incremented by one (S66) Subsequently, it is decided whether the number of off-track occurrence stored in the memory 27 is a specified value (for example, 10 times) or more. If the number of off-track occurrence is less than the specified frequency, the defect relief mode processing is not performed. To the contrary, if the number of off-track occurrence is the specified value or more, a ratio of the number of matching to the number of off-track occurrence is calculated by dividing the number of matching stored in the number of rotation angle match storage area 27-2 by the number of off-track occurrence stored in the memory 27. Then, it is decided whether the above ratio of the number of matching is a specified value (for example, 90%), or more. If the above ratio is less than the specified value, the defect relief mode processing is not performed. On the other hand, if the above ratio is no less than the specified value, the defect relief mode is instructed (S68).

As such, on the occurrence of off-track, the point of occurrence of the off-track is examined. The occurrence of frequent off-track at an identical point is detected by calculating the ratio of the number of matching of the defective rotation angle to the number of off-track occurrence, so as to decide to be a defect (dust, scratch, etc.) Further, in the case of read operation, the defect relief mode is instructed to the off-track detection processing 22-1, so as to relax the off-track detection condition. To the contrary, in the case that off-track did not occur frequently at an identical point, it is decided that the off-track is not caused by a defect, and the off-track detection condition is not relaxed.

Second Embodiment of the Off-track Relief Processing

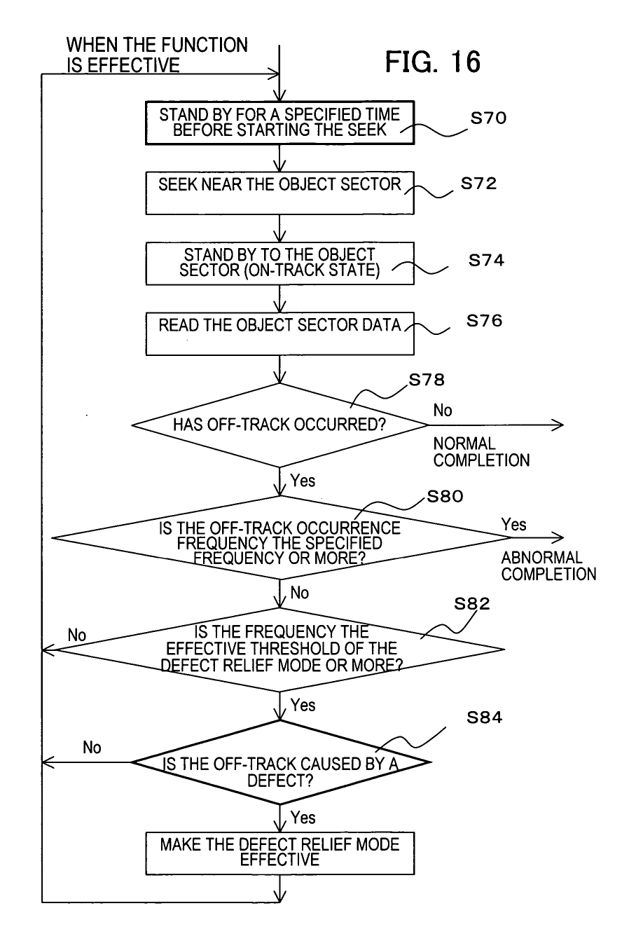

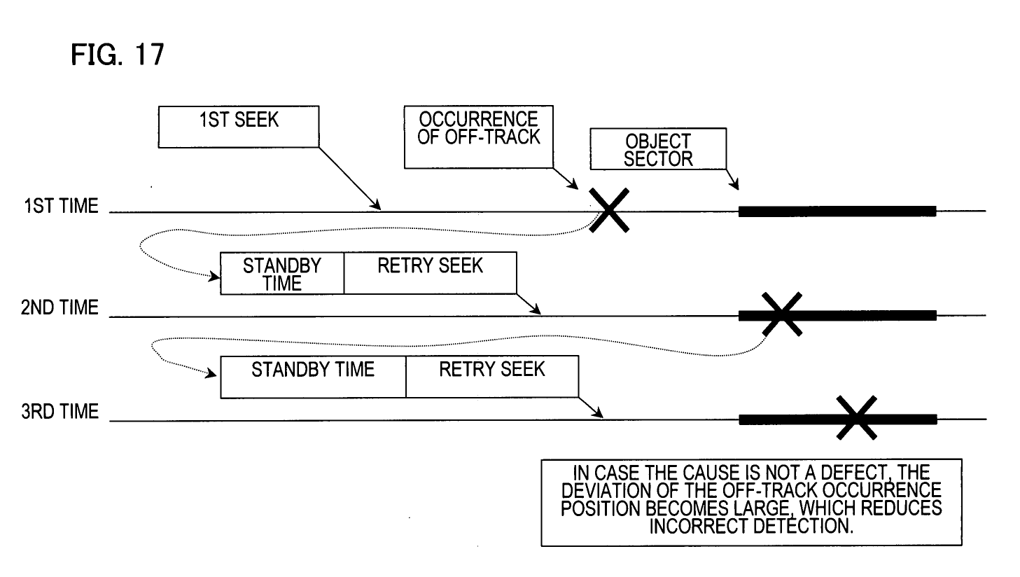

Next, off-track relief processing executed in MPU 20 according to a second embodiment is described below. FIG. 16 shows an off-track relief processing flowchart according to the second embodiment of the present invention. FIG. 17 shows an operation explanation diagram thereof.

Referring to FIG. 17, the processing shown in FIG. 16 is described hereafter.

(S70) Before starting seek operation, MPU 20 keeps standing by for a specified time.

(S72) MPU 20 issues a command to DSP 22 so as to perform seek operation of carriage 14 to the vicinity of an object sector (track) to be read. DSP 22 detects a current position from a sector ID, and performs seek operation of the carriage 14 by use of a position error between the target position and the current position through known seek control.

(S74) On detection of the carriage 14 reaching the target position (track 100 having object sector 102 shown in FIG. 8) from the sector ID, MPU 20 waits for the rotation to the light beam position from carriage 14, while maintaining the light beam of the carriage an on-track state.

(S76) MPU 20 starts read operation of object sector 102 through the read circuit 26. The read data is then transferred to RAM 27 from the read circuit 26.

(S78) In the mean time, DSP 22 detects whether the level of a track error signal TES exceeds a predetermined threshold (i.e. whether off-track has occurred) through the off-track detection processing 22-1. If no occurrence of the off-track is notified from DSP 22, MPU 20 completes the processing normally. In this case, the ODC circuit 24 transfers data of RAM 27 to the host.

(S80) On the other hand, on detection of the off-track during reading the read object sector 102, DSP 22 notifies MPU 20 of the above detection. MPU 20 counts the number of an off-track occurrence, and decides whether the number of off-track occurrence reaches a specified value or more during the read operation concerned. If the number of off-track occurrence is equal or more than the specified value (for example, 16 times), the processing is terminated abnormally.

(S82) To the contrary, if the number of off-track occurrence is less than the specified value, it is highly probable that a defect (dust, scratch, etc.) has occurred. Therefore, first, MPU 20 decides whether the number of off-track occurrence is equal or more than an effective threshold of the defect relief mode (for example, 10 times). The above effective threshold is set smaller than the aforementioned threshold for triggering the abnormal termination. Namely, the effective threshold is provided for detecting a prior stage to the abnormal termination. If the number of off-track occurrence is less than the above effective threshold, the process is returned to step S70 for performing retry seek operation, without execution of the defect relief mode. As shown in FIG. 17, after moving the carriage to a different track once, and waiting for a specified time, MPU 20 again seeks the track having the object sector.

(S84) Meanwhile, if the number of off-track occurrence is equal or more than the effective threshold, as shown in FIGS. 5, 6, 14 and 15, MPU 20 decides whether the off-track occurs continuously or frequently at the point (rotation position) of the off-track occurrence through the defect decision processing 20-1, 20-1A, so as to decide whether the off-track is caused by a defect. When the defect decision processing 20-1, 20-1A decides that the off-track is not caused by a defect, MPU 20 does not execute the defect relief mode. Instead, the process is returned to step S70 for performing retry seek operation. As shown in FIG. 17, after moving the carriage to a different track once, MPU 20 waits for a specified time, and then seeks the track having the object sector again. To the contrary, when the defect decision processing 20-1, 20-1A decides that the off-track is caused by a defect, MPU 20 instructs the off-track detection processing 22-1 in DSP 22 to perform the defect relief mode, and relaxes the off-track detection condition. Thereafter, the process is returned to step S70 for performing retry seek operation.

As shown in FIG. 17, when the off-track is detected while tracing the track toward the object sector after landing at the first seek, the landing point of the second time on the track concerned is different from that of the first time, because there is a pause for the specified time (standby time) before the retry seek operation. The above is similar to the cases of the third time and thereafter.

Using the above-mentioned method, when the cause is not a defect, deviation of the off-track occurrence position immediately after seek becomes particularly large. Accordingly, incorrect defect detection can be reduced. For example, in the embodiment shown in FIGS. 2 and 3, since the defect detection margin is set to be a few sectors, the above-mentioned method is particularly effective.

Third Embodiment of the Off-track Relief Processing

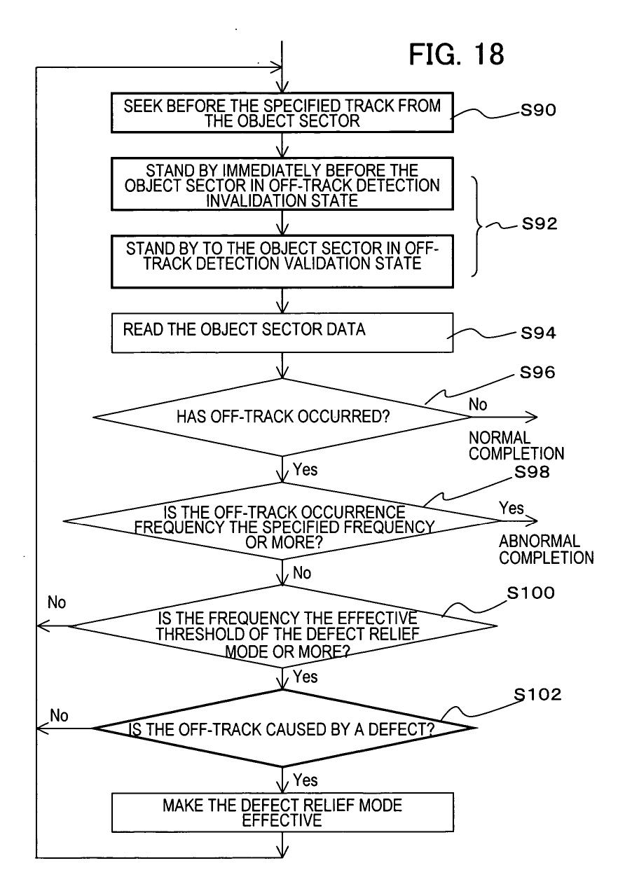

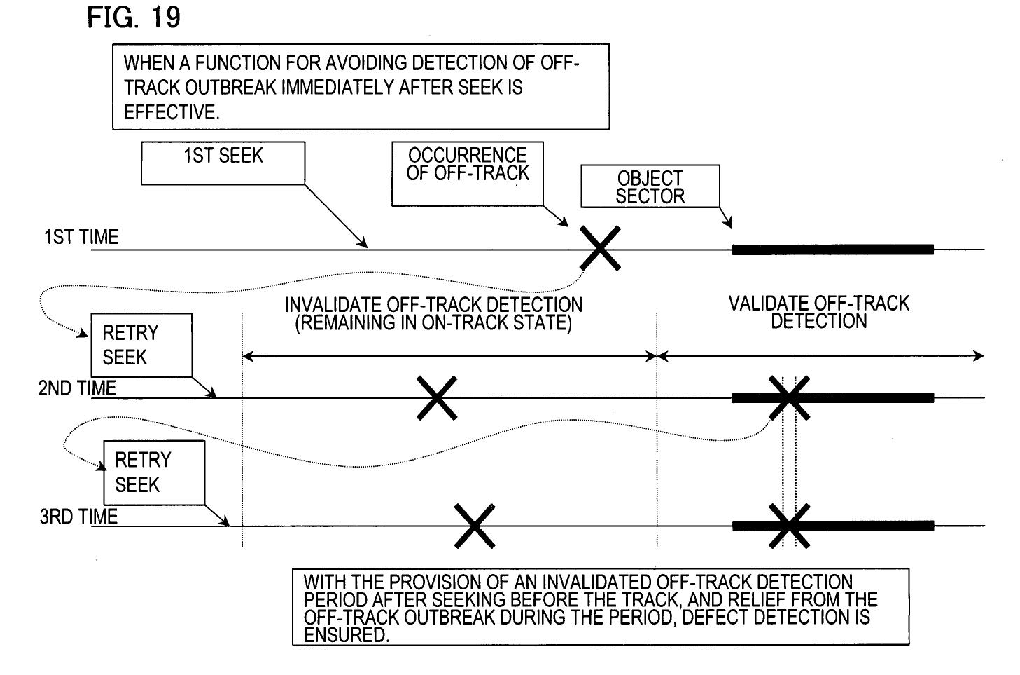

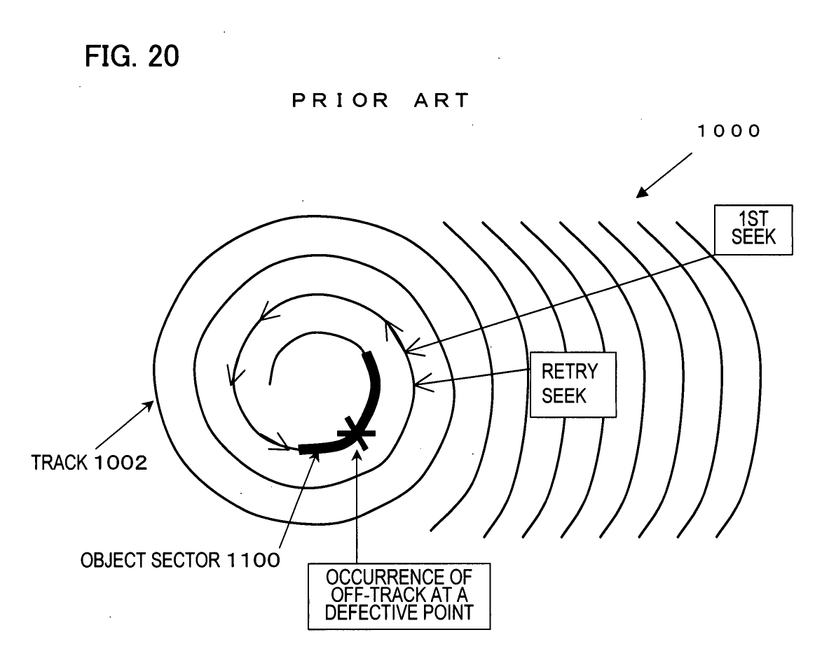

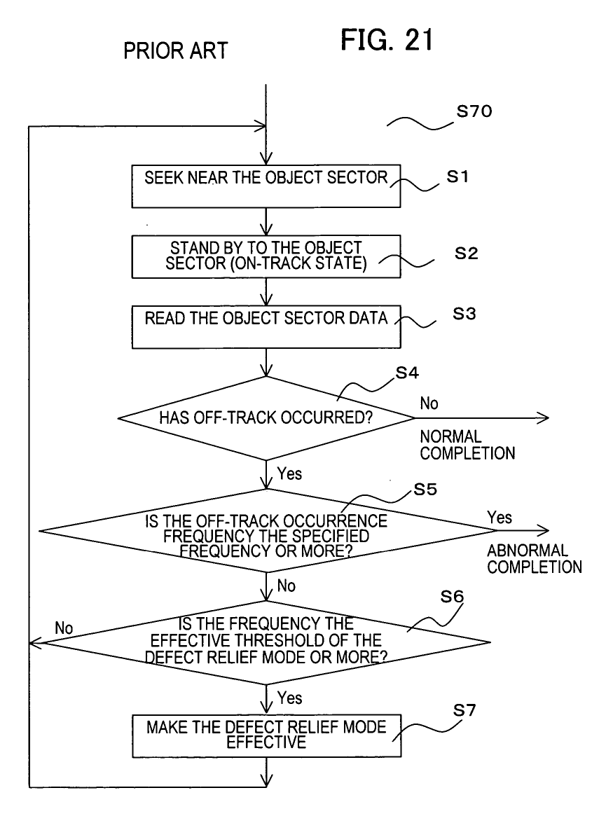

Next, off-track relief processing executed in MPU 20 according to a third embodiment is described below. FIG. 18 shows an off-track relief processing flowchart according to the third embodiment of the present invention. FIG. 19 shows an operation explanation diagram thereof.

Referring to FIG. 19, the processing of FIG. 18 is described hereafter.

(S90) MPU 20 issues a command to DSP 22 so as to perform seek operation of the carriage 14 to a track corresponding to a specified number of tracks prior to the track having an object sector to be read. DSP 22 detects a current position from a sector ID, and performs seek control of the carriage 14 by use of a position error between the target position and the current position through known seek control.

(S92) On detection of the carriage 14 reaching the target position (track 100 having object sector 102 shown in FIG. 8) from the sector ID, MPU 20 invalidates the off-track detection processing 22-1 in DSP 22, and waits for the rotation, while maintaining the light beam position an on-track state (refer to FIG. 19). Thereafter, immediately before the object sector, MPU 20 cancels the invalidation of (i.e. validates) the off-track detection processing 22-1 in DSP 22, and waits for the rotation, while maintaining the light beam position an on-track state.

(S94) MPU 20 starts read operation of object sector 102 through the read circuit 26. The read data is then transferred to RAM 27 from the read circuit 26.

(S96) In the mean time, DSP 22 detects whether the level of a track error signal TES exceeds a predetermined threshold (i.e. whether off-track has occurred) through the off-track detection processing 22-1. If no occurrence of the off-track is notified from DSP 22, MPU 20 completes the processing normally. In this case, the ODC circuit 24 transfers data of RAM 27 to the host.

(S98) On the other hand, on detection of the off-track during reading the read object sector 102, DSP 22 notifies MPU 20 of the above detection. MPU 20 counts the number of an off-track occurrence, and decides whether the number of off-track occurrence reaches a specified value or more, during the read operation concerned. If the number of off-track occurrence is equal or more than the specified value (for example, 16 times), the processing is terminated abnormally.

(S100) To the contrary, if the number of off-track occurrence is less than the specified value, MPU 20 decides whether the number of off-track occurrence is equal or more than an effective threshold of the defect relief mode (for example, 10 times). The above effective threshold is set smaller than the aforementioned threshold for triggering the abnormal termination. Namely, the effective threshold is provided for detecting a prior stage to the abnormal termination. If the number of off-track occurrence is less than the above effective threshold, the process is returned to step S90 for performing retry seek operation, without execution of the defect relief mode. As shown in FIG. 19, after moving the carriage to a different track once, MPU 20 again seeks the track having the object sector.

(S102) Meanwhile, if the number of off-track occurrence is equal or more than the effective threshold, as shown in FIGS. 5, 6, 14 and 15, MPU 20 decides whether the off-track occurs continuously or frequently at the point (rotation position) of the off-track occurrence through the defect decision processing 20-1, 20-1A, so as to decide whether the off-track is caused by a defect. When the defect decision processing 20-1, 20-1A decides that the off-track is not caused by a defect, MPU 20 does not execute the defect relief mode. Instead, the process is returned to step S90 for performing retry seek operation. As shown in FIG. 19, after moving the carriage to a different track once, MPU 20 seeks the track having the object sector again. To the contrary, when the defect decision processing 20-1, 20-1A decides that the off-track is caused by a defect, MPU 20 instructs the off-track detection processing 22-1 in DSP 22 to perform the defect relief mode, and relaxes the off-track detection condition. Thereafter, the process is returned to step S90 for performing retry seek operation.

As shown in FIG. 19, when the off-track is detected while tracking toward the object sector from landing at the first seek, the off-track detection is invalidated from after the retry seek operation of the second time to immediately before the object sector. The above is similar to the cases of the third time and thereafter.

Through the above-mentioned method, when the cause is not a defect, incorrect defect detection can be reduced, because the occurrence of off-track immediately after seek is not detected. Thus, defect detection can be performed securely. For example, in the embodiment shown in FIGS. 2 and 3, since the defect detection margin is set to be a few sectors, the above-mentioned method is particularly effective.

Other Embodiments

In the above-mentioned embodiments of the present invention, a magneto-optical disk apparatus has been exemplified as an optical disk apparatus. However, it is also possible to apply to other optical disk apparatus, such as a CD apparatus and a DVD apparatus. Similarly, the outer shape of the optical disk is not limited to a round shape, and other shapes such as rectangle maybe applicable.

Furthermore, the above description has been illustrated for an optical head of separate type in which an optical drive system is movable. However, it is also applicable to a head having an optical system integrally formed with an optical drive system.

As having been described above, according to the present invention, a defect (dust, scratch, etc.) is decided by examining the point of occurrence of off-track when the off-track occurs at an identical point, and by detecting the occurrence of continuous off-track at an identical point. In the case of read operation, an off-track detection condition is relaxed. To the contrary, when the off-track does not occur continuously at an identical point, it is decided the off-track is not caused by a defect, and the off-track detection condition is not relaxed. Thus, it becomes possible to distinguish an outbreak of off-track which occurs immediately after seek from off-track caused by a defect. Movement to a neighboring track can be prevented even when the outbreaks of off-track continue, and accordingly, an appropriate off-track relief processing against a defect can be realized.

The foregoing description of the embodiments is not intended to limit the invention to the particular details of the examples illustrated. Any suitable modification and equivalents may be resorted to the scope of the invention. All features and advantages of the invention which fall within the scope of the invention are covered by the appended claims.

What is claimed is:

1. An optical disk apparatus for at least reading information recorded on a track of an optical disk comprising:
an optical head for irradiating light onto the optical disk, receiving the light from the optical disk, and moving in the transversal direction of the track of the optical disk;
a spindle motor for rotating the optical disk;
a servo controller for controlling a position of the optical head according to a track error signal generated from the received light from the optical disk by means of the optical head, and detecting off-track from the track error signal and a predetermined off track condition; and
a controller for relaxing said off-track detection condition in response to a notification of the off-track,
wherein the controller monitors a rotation position of the optical disk in which the off-track has occurred according to the off-track detection, detects that the off-track has occurred a plurality of times in an identical position through the monitoring of the rotation position, and relaxes the off-track detection condition.

2. The optical disk apparatus according to claim 1,
wherein the controller monitors the rotation position of the optical disk in which the off-track has occurred, from a sector ID included in a readout signal from the optical head.

3. The optical disk apparatus according to claim 1,
wherein the controller monitors the rotation position of the optical disk in which the off-track has occurred, from the rotation position of the spindle motor.

4. The optical disk apparatus according to claim 1,
wherein the controller detects that the off-track is occurred continuously for a plurality of times in an identical position, and relaxes the off-track detection condition.

5. The optical disk apparatus according to claim 1,
wherein the controller detects that a ratio of the number of off-track having occurred in an identical position to the number of off-track occurrence is a specified value or more, and relaxes the off-track detection condition.

6. The optical disk apparatus according to claim 1,
wherein, according to the off-track detection, the controller performs retry seek operation of the optical head.

7. The optical disk apparatus according to claim 6,
wherein, according to the off-track detection, the controller performs retry seek operation of the optical head after changing the target position of the track having the object sector.

8. The optical disk apparatus according to claim 7,
wherein, according to the off-track detection, the controller performs seek operation of the optical head to a different track, and after waiting for a specified time, performs retry seek operation to the track having the object sector.

9. The optical disk apparatus according to claim 6,
wherein, according to the off-track detection, the controller performs seek operation of the optical head to a different track, and performs retry seek operation to the track having the object sector, and then invalidates the off-track detection until the optical head reaches immediately before the object sector.

10. The optical disk apparatus according to claim 1,
wherein, according to the off-track detection, the controller monitors a rotation position of the optical disk in which the off-track has occurred, detects that the off-track has occurred a plurality of times in an identical position through monitoring the rotation position in the case that the number of off-track occurrence reaches a specified value or more, and relaxes the off-track detection condition.

11. An off-track relief processing method for the optical disk apparatus, comprising the steps of:
seeking an optical head to the track having an object sector by moving said optical head, which irradiates light onto an optical disk, receives the light from the optical disk, and at least reads information recorded on a track of the optical disk, to the transversal direction of the track;
detecting off-track from a track error signal generated from the received light from the optical disk by means the optical head and a predetermined off track condition;
monitoring a rotation position of the optical disk in which the off-track has occurred according to the off-track detection;
detecting that the off-track has occurred a plurality of times in an identical position through the monitoring of the rotation position; and
relaxing said off-track detection condition.

12. The off-track relief processing method for the optical disk apparatus according to claim 11,
wherein the step for monitoring the rotation position comprises a step of monitoring the rotation position of the optical disk in which the off-track has occurred, from a sector ID included in a readout signal from the optical head.

13. The off-track relief processing method for the optical disk apparatus according to claim 11,
wherein the monitoring step comprises a step of monitoring the rotation position of the optical disk in which the off-track has occurred, from the rotation position of a spindle motor for rotating the optical disk.

14. The off-track relief processing method for the optical disk apparatus according to claim 11,
wherein the relaxing step comprises a step of relaxing the off-track detection condition by detecting that the off-track is continuous occurred for a plurality of times in an identical position.

15. The off-track relief processing method for the optical disk apparatus according to claim 11,
wherein the relaxing step comprises a step of relaxing the off-track detection condition on detecting that a ratio of the number of off-track having occurred in an identical position to the number of off-track occurrence is a specified value or more.

16. The off-track relief processing method for the optical disk apparatus according to claim 11, further comprising the step of:
performing retry seek operation of the optical head according to the off-track detection.

17. The off-track relief processing method for the optical disk apparatus according to claim 16,
wherein the retry seek step comprises a step of performing the retry seek operation of the optical head after changing the target position of the track having the object sector, according to the off-track detection.

18. The off-track relief processing method for the optical disk apparatus according to claim 17,
wherein, the retry seek step comprises the steps of:
performing seek operation of the optical head to a different track; and
performing retry seek operation to the track having the object sector after waiting for a specified time.

19. The off-track relief processing method for the optical disk apparatus according to claim 16,
wherein the retry seek step comprises the steps of:
performing seek operation of the optical head to a different track according to the off-track detection;
performing retry seek operation to the track having the object sector; and
invalidating the off-track detection until the optical head reaches immediately before the object sector.

20. The off-track relief processing method for the optical disk apparatus according to claim 11, further comprising the steps of:
according to the off-track detection, deciding whether the number of off-track occurrence reaches a specified value or more; and
executing said relax step when the number of off-track occurrence reaches the specified value or more.
